(19) United States
(12) Patent Application Publication
(10) Pub. No.: US 2013/0324236 A1
(43) Pub. Date: Dec. 5, 2013

(54) PROTOCOL CONVERTER

(71) Applicant: TECHART LLC, Sunny lsles Beach, FL (US)

(72) Inventor: Jefferson Paulo KOPPE, Curtiba-PR (BR)

(21) Appl. No.: 13/909,170

(22) Filed: Jun. 4, 2013

Related U.S. Application Data
(60) Provisional application No. 61/655,041, filed on Jun. 4, 2012.

(51) Int. Cl. A63F 13/06

(52) U.S. Cl. CPC A63F 13/06
USPC 463/29

(57) ABSTRACT

A method, system and apparatus by which otherwise incompatible first and second component, each having its own protocol will operate in a compatible fashion. The protocol of each component is determined, data from a first component in a form based on the first protocol is transformed into data in a form based on a second protocol and thereafter sent to the second component. The data may be normalized upon receipt from the first component.

### CROSS-REFERENCE TO RELATED APPLICATION

This application is based on U.S. Provisional Patent Application No. 61/655,041 filed 4 Jun. 2012, the entirety of which is hereby incorporated by reference.

### FIELD OF THE INVENTION

This invention relates to a protocol converter for video game controllers. More specifically, this invention relates to a protocol converter for video game controllers so that one type of video game controller may be utilized with an otherwise incompatible video game console.

### BACKGROUND OF THE INVENTION

A video game platform refers to the equipment and associated software on which a video game operates. Thus, in the broad sense the platform may include a console upon which the software operates, a controller to be utilized by the person who is to play the video game, and a video output. The two types of video game platforms currently dominating the video game market are dedicated video game platforms and personal computers (PCs). Associated with these platforms are a variety of different video game controllers.

A video game controller is the equipment that enables an end user (i.e., a player of a video game) to interact with the game while the game software is functioning. Different types of game controllers include but are not limited to a keyboard, a mouse, a joystick, and a gamepad. The controller allows the end user to interact with the game by transmitting data (e.g., instructions) to a game platform utilizing a specific scheme of communication, known generally as a protocol.

Game controllers are typically designed to interact with only one style of game platform that is usually, but not exclusively, provided by the manufacturer of the game console. Manufacturers make game consoles and controllers that use proprietary data communication protocols. These various protocols are not interchangeable but to the contrary they only enable communication between specific controllers and the associated console. Further, game controllers and consoles tend to have proprietary physical and electrical interfaces, which is an additional source of incompatibility. Finally, data transmitted by game controllers is typically not modifiable and this presents limitations to the game playing experience over which end users have expressed dissatisfaction. All of the above prevents cross platform utilization of game controllers.

Of course the end user or video game player may choose to acquire more than one video game controller to accommodate various game platforms. However, as the complexity of game controllers increases, so does their cost, which makes it prohibitively expensive for the majority of users to own more than one game controller. Furthermore, a typical end user will achieve a high level of familiarity and proficiency with a particular type or make of game controller. It is then highly inconvenient for such a user to gain a similar facility with another game controller.

### SUMMARY OF THE INVENTION

The present invention overcomes these and other shortcomings by providing a protocol converter that permits one controller to be used with a variety of game consoles previously thought to be incompatible and that permits a game controller to be operated by a variety of controllers previously thought to be incompatible.

The protocol converter is positioned between a controller and a console. The converter determines the type of console and the type of controller and converts the signals therebetween so that the controller sends signals according to the protocol for which it has been designed, regardless of the console to which it is operably connected, and the console receives signals according to the protocol for which it has been designed regardless of the controller to which it is operably connected.

### BRIEF DESCRIPTION OF THE DRAWINGS

The foregoing benefits and advantages of the protocol converter, along with other benefits and advantages to be attained by its use, will be apparent upon reading the following detailed description taken in conjunction with the drawings.

In the drawings, wherein like reference numerals identify corresponding components:

FIG. 1 is a block diagram indicating a protocol converter interposed between a controller and a console;

FIG. 2 is a perspective illustration of a protocol converter;

FIG. 3 is a flow chart of the operation of the protocol converter;

FIG. 4 is a flow chart of an alternate operation of the protocol converter;

FIG. 5 is a diagrammatic representation of a first memory;

FIG. 6 is a diagrammatic representation of a second memory;

FIG. 7 is a diagrammatic representation of a third memory; and

FIG. 8 is a diagrammatic representation of a fourth memory.

### DETAILED DESCRIPTION

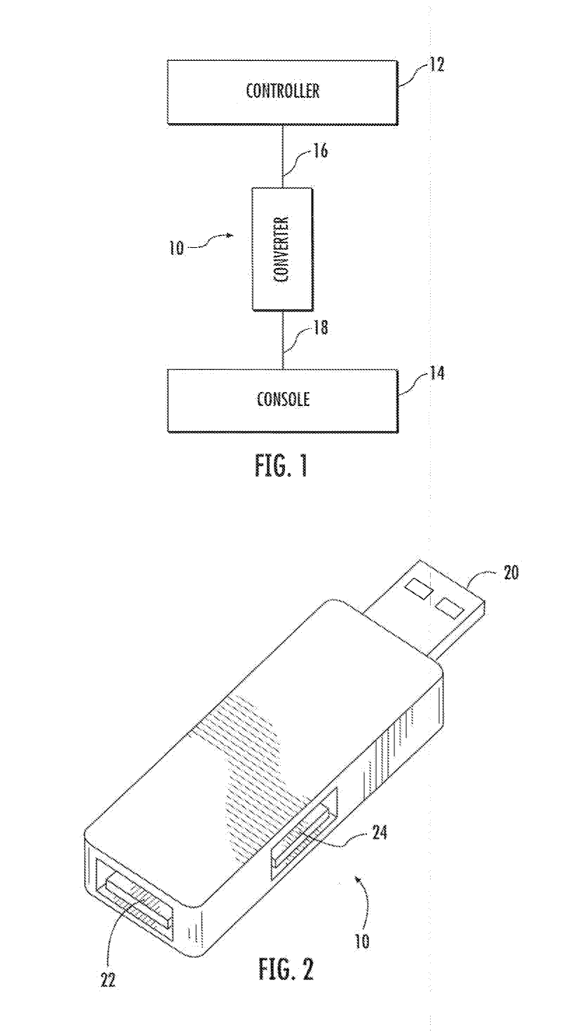

Referring first to FIG. 1, a protocol converter 10 is illustrated as operably connected between a controller 12 and a console 14. The operable connection may be wireless or may be accomplished by wires or cables such as wire 16 between the converter and the controller and wire 18 between the converter and the console.

The controller and console may, for example, be custom made or may be of the type commercially available such as one of the XBOX family of products marketed by Microsoft Corporation, one of the Wii family of products marketed by Nintendo of America, Inc. and/or one of the Playstation family of products marketed by Sony Corporation. Each of these families of products may include one or more forms of controller and at least one form of console.

Referring next to FIG. 2, a converter 10 may be configured as an elongated, rectangular unit having a first end 20 and a second end 22. The first end 20 may include a projection or plug that will connect to a standard USB port. The second end 22 may be formed as a standard USB port or receptacle including a recess to receive a plug. Additional ports 24 may be formed within the body of the converter 10 and additional plugs may be provided on the converter.

When the converter 10 is operably connected to the controller 12 as illustrated in FIG. 1 (or without the intervening cable or wire 16, since wireless communication including but not limited to Bluetooth communication is contemplated) a conventional USB handshake protocol allows the controller to recognize the converter 10. Similarly when the converter 10 is operably connected to the console 14 as illustrated in FIG. 1 (or without the intervening cable or wire 18) a conventional USB handshake protocol allows the console to recognize the converter 10.

Examples of the controller include, but are not limited to, the ST Ericsson ISP1161A1, the NXP ISP1161A1BD, and the Philips ISP1161BD.

The controller may have a flash or read-only memory that runs software, referred to as firmware, which is stored therein. The firmware serves as the control program for the converter 10. The firmware controls how external signals, communicated to it by the controller, are processed. The firmware interprets data or input signals (which adhere to a certain controller-dependent protocol) and converts those signals to an appropriate output that adheres to a console-dependent protocol).

In one embodiment, the controller includes ATMEL AT90USB1286 microcontroller or processor that has the advantage of executing powerful instructions in a single clock cycle, thus achieving throughputs approaching 1 MIPS per MHz, while balancing power consumption with processor speed. The handshake protocol may be stored in the controller memory, processor, etc.

The converter 10 will now be explained in greater detail. For the purpose of the following explanation, which is to be understood as non-limiting it is to be appreciated that a controller may include a series of buttons that may be identified by the letters A, B, X and Y as is conventional.

Prior to the present invention, a controller typically could be used only with a specific console from the same manufacturer. They were considered “paired”. The data stream from the controller to the console was such that the data representing the status of button “A” would be correctly interpreted and not mistaken as being data representing the status of button “B”. However, controllers from one manufacturer typically were not compatible with consoles from another manufacturer and vice-versa.

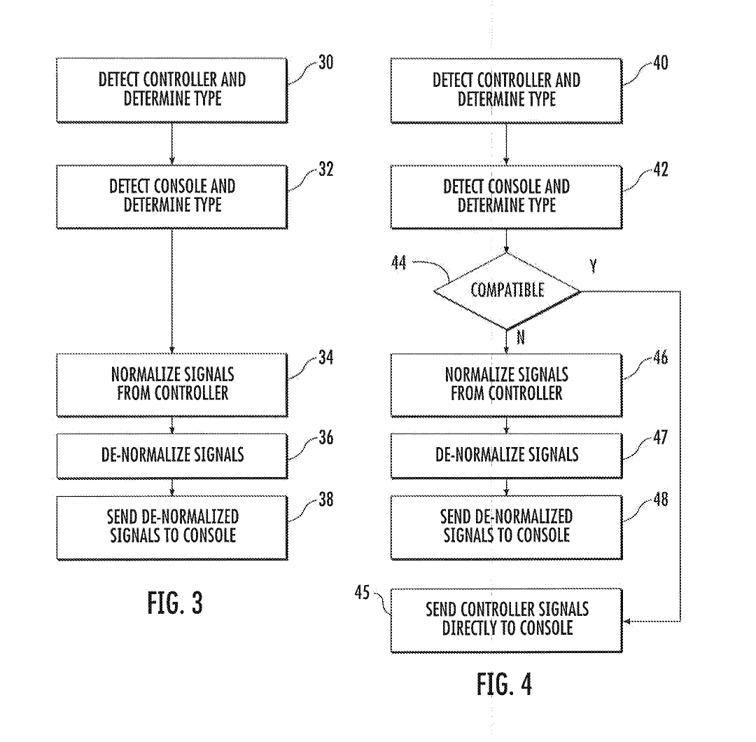

Referring to FIG. 3, the steps in the operation or use of a converter will be explained. Using standard USB handshake protocol the converter detects the controller and determines the type of controller at step 30. Using standard USB handshake protocol the converter detects the console and determines the type of console at step 32. Alternatives to standard USB handshake protocol whether automatic detection or manual detection may be used. The sequence of steps 30 and 32 may be reversed depending upon various factors such as the sequence in which the controller and console are connected to the converter.

The converter normalizes or standardizes the signals or data stream from the controller at step 34. Thus the normalized data is now independent of the protocol of the controller that generated the data or signals. The normalization is based on the converter recognizing the type of controller being utilized and thus recognizing the protocol utilized by the controller to generate the data or signals.

The next step is to de-normalize the signals or data at step 36. This step changes the data so that the data is compatible with the protocol of the console. The de-normalization is based on the converter recognizing the type of console being utilized and thus recognizing the protocol utilized by the console to receive and interpret the data or signals. Then, at step 38, the de-normalized data or signals is sent to the console and are properly interpreted by the console such that the video game functions properly even though the controller and console are incompatible without the use of the protocol converter.

An alternate approach is generally illustrated in the flow chart of FIG. 4. Again using standard USB handshake protocol the converter detects the controller and determines the type of controller at step 40. Using standard USB handshake protocol the converter detects the console and determines the type of console at step 42. Alternatives to standard USB handshake protocol whether automatic detection or manual detection may be used. The sequence of steps 40 and 42 may be reversed depending upon various factors such as the sequence in which the controller and console are connected to the converter.

The converter next determines if the controller and console are compatible at step 44, i.e., do the controller and console use the same protocol for sending and receiving data and signals. If they are compatible, the controller may allow data and signals from the controller to flow directly to the console at step 45. This is an option in that it should be appreciated that normalization of the data and signals may always be provided if desired.

In the event that the controller and console are not compatible, the controller normalizes or standardizes the signals or data stream from the controller at step 46. Thus the normalized data is now independent of the protocol of the controller that generated the data or signals. The normalization is based on the converter recognizing the type of controller being utilized and thus recognizing the protocol utilized by the controller to generate the data or signals.

The next step is to de-normalize the signals or data at step 47. This step changes the data so that the data is compatible with the protocol of the console. The de-normalization is based on the converter recognizing the type of console being utilized and thus recognizing the protocol utilized by the console to receive and interpret the data or signals. Then, at step 48, the de-normalized data or signals is sent to the console and are properly interpreted by the console such that the video game functions properly even though the controller and console are incompatible without the use of the protocol converter.

The following explains in greater detail solving the problem of incompatibility of converters and consoles by the normalization (or standardization) of data and signals and the de-normalization of the data and signals.

For purpose of explaining the protocol as between a controller and a console, it is easier to consider this in the context of a “memory” where data is stored even though in the context of a controller and its associated console there is a real time transfer of data that may occur without any intervening memory.

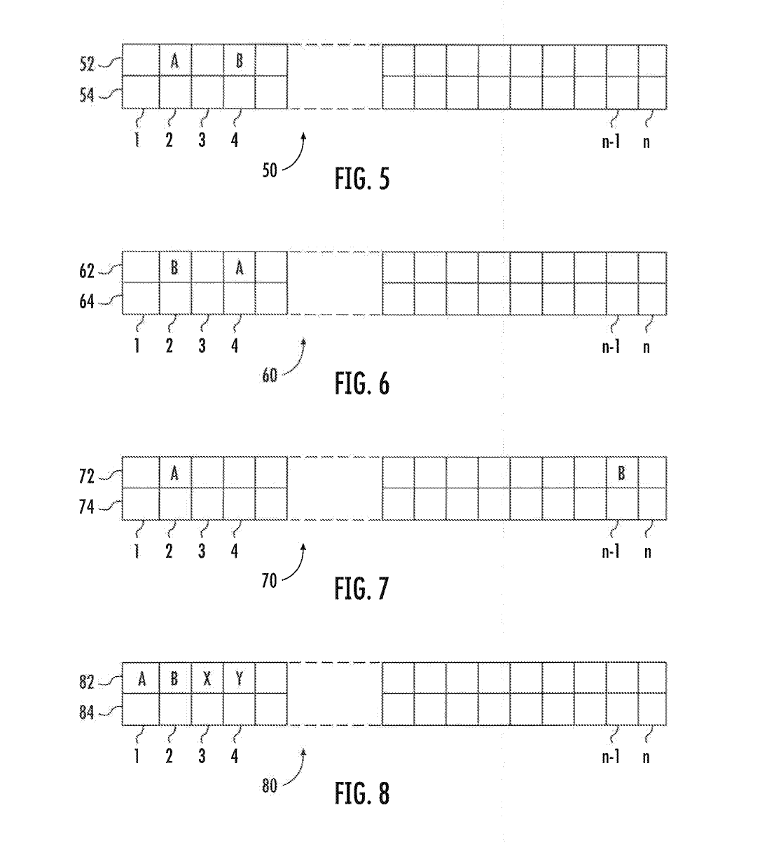

Referring to FIG. 5, a first memory 50 that is illustrated solely for the purpose of explanation has having two “rows” 52, 54, each “row” having “n” storage locations identified as 1, 2, 3, . . . n−1, and n. Presume that the protocol for a particular controller correlates the information about button “A” with storage location #2 and the information about button “B” with storage location #4, each in row 52. Thus the information in row 52 of the memory represents the particular button or feature of the controller. Presume also that the degree or extent of pressure imposed on the buttons is represented by a value from 0 to 255—a total of 256 potential values with 0 indicating no pressure on the button and 255 indicating maximum pressure on the button. The choice of 256 potential values is predicated on the ease of a binary representation of 2⁸. The information in row 44 thus indicates the status (off, partial pressure, total pressure) of the respective button. Thus the information in row 54 of the controller at location 2 is indicative of the status of button A.

If, in this example, button “A” is not depressed at all and button “B” is depressed 50%, the memory 50 would have the value 0 in location 2 of row 54 and a value 2⁴ in location 4 of row 54. At this point it should be appreciated that the information in “memory” is the status or value of the buttons on the controller. The use of a two-row memory is to graphically explain the foregoing concept. The use of a memory having “n” locations it to graphically explain that the controller may have a large number of “buttons” or “features” that are used to operate the video game.

Referring next to FIG. 6, a second memory 60 is illustrated solely for the purpose of explanation has having two “rows” 62, 64, each “row” having “n” storage locations identified as 1, 2, 3, . . . n−1, and n. Presume that the protocol for a particular controller, different from the controller associated with the memory of FIG. 5 correlates the storage location #4 with the information about button “A” on the controller and the storage location #2 with the information about button “B” on the controller. The location of the information is understood to be opposite in location from the location in the memory of FIG. 5. Presume that the degree or extent of pressure imposed on the buttons is represented by a value from 0 to 255—a total of 256 potential values with 0 indicating no pressure on the button and 255 indicating maximum pressure on the button. The choice of 256 potential values is predicated on the ease of a binary representation of 2⁸. The information in row 64 thus indicates the status (off, partial pressure, total pressure) of the respective button. Thus the information in row 64 of the controller at location 4 is indicative of the status of button A.

Finally, referring next to FIG. 7, consider a third memory 70 associated with a controller that is different from the controllers that were explained in connection with FIGS. 5 and 6. The third memory may have two “rows” 72, 74, each “row” having “n” storage locations identified as 1, 2, 3, . . . n−1, and n. Presume that the protocol for a third controller correlates the information about button “A” in storage location #2 and the information about button “B” in storage location #n−1. Presume also that the degree or extent of pressure imposed on the buttons is represented by a value from 0 to 100—a total of 101 potential values with 0 indicating no pressure on the button and 100 indicating maximum pressure on the button. The information in row 74 indicates the status (off, partial pressure, total pressure) of the respective button.

Prior to the present invention, when a console was connected to the wrong (i.e., non-compatible) controller, the data stream would be misread, or misinterpreted, or not recognized at all. Thus, for example if a console expected to receive data correlated to data locations in memory 50 but instead was connected to a controller that sent data correlated to the locations in memory 60 or 70, it should be appreciated that the controller/console combination would work incorrectly or not at all. The data in the data stream was not at the location where it was expected. The controller and console were not compatible.

Referring next to FIG. 8, a memory 80 having two rows 82, 84 with “n” data locations for each row is diagrammatically illustrated. Memory 80 will be referred to as a “normalizing” or standardizing memory. By way of example, memory 80 could store information relating to button “A” at location 1, information about button “B” at location 2, etc. The status of each button (row 84) could be any system —2⁸ as described, 0-100% as described, or any other system.

When the protocol converter 10 is connected to a controller, the converter detects the controller and determines the nature or type of controller via standard USB handshake protocol. Suppose the controller is the type that transmits a data stream with data locations and values corresponding to the locations and values in memory 50. The protocol converter “normalizes” the data, takes the data from memory 50 and puts the data into the standardized location/format of the memory of FIG. 8.

Then, when a console is connected to the protocol converter, the converter determines the nature of the console via standard USB handshake protocol. Suppose the console is the type that receives a data stream with data locations and values corresponding to the locations and values in memory 70. The protocol converter takes the data from the normalized memory of FIG. 8 and transfers the data to the format of FIG. 7.

Thus, for example, depressing button “A” on any of the types of controllers to any value (50%, 75%, 100%) is “normalized” as to location (i.e., location 1 of FIG. 8) and as to value, and then de-normalized as to location and value into a data stream format suitable for the console.

With the foregoing as an explanation, it should be appreciated that if the converter determines that the controller and console are compatible, then data normalizing and de-normalizing are not needed although data normalizing and de-normalizing may be provided. In other words, one option is to by-pass the normalizing and de-normalizing steps.

In connection with FIGS. 5-8, the “storage” of data and the normalizing and de-normalizing of data are explained in the context of memories. Thus, for example, the value or status of a button (e.g., button “A”) is stored in memory until that value or status changes at which time a new value or status is stored in memory and replaces the prior value or status.

The use of memories or data storage, in any form, is illustrative and non-limiting. The use of multiple memories, one for each type of controller, is illustrative and non-limiting. A single multi-dimensional memory may be utilized. A memory in the form of software, e.g., a computer program that “stores” or maintains the data (e.g., value or status of a button) until changed, and the type of controller and console, until changed, and manipulates the data to accomplish normalization and de-normalization may be used.

The foregoing is an illustrative description of the protocol converter for creating compatibility as between controllers and consoles that are otherwise incompatible for video game playing. In the present context, the “console” may also be a computer or other product and the controller may include a keyboard, joystick, “triggers” or other types of controls instead of or in addition to push buttons.

What is claimed is:

1. A method for creating compatibility as between otherwise incompatible components, each having its own protocol, comprising:
determining the protocol associated with a first component;
determining the protocol associated with a second component;
receiving data from the first component, said data being in a form based on the protocol associated with the first component; and
sending the data to the second component in a form based on the protocol associated with the second component.

2. The method according to claim 1, further including:
determining whether or not the protocol associated with the first component and the protocol associated with the second component are compatible.

3. The method according to claim 1, further including:
normalizing the data received from the first component; and
de-normalizing the normalized data prior to sending the data to the second component.

4. A converter for creating compatibility as between otherwise incompatible components, each having its own protocol, comprising:
means for determining the protocol associated with a first component;
means for determining the protocol associated with a second component; and
means for converting data which is to be received from a first component into data based on the protocol associated with the second component.

5. The converter according to claim 5, wherein the means for converting data further includes:
means for normalizing the data to be received from a first component.

6. The converter according to claim 6, wherein the means for converting data further includes:
means for de-normalizing the data received from a first component based on the protocol associated with a second component to which the data is to be sent.
